(19) United States
(12) Patent Application Publication
(10) Pub. No.: US 2025/0122021 A1
(43) Pub. Date: Apr. 17, 2025

(54) METHOD AND TRANSFER STATION FOR COMPACTING A FLOW OF GOODS IN AN OVERHEAD CONVEYOR SYSTEM

(71) Applicant: Dürkopp Fördertechnik GmbH, Bielefeld (DE)

(72) Inventors: Pascal REHM, Bielefeld (DE); Thomas JOHANNESMANN, Bielefeld (DE)

(21) Appl. No.: 18/907,768

(22) Filed: Oct. 7, 2024

(30) Foreign Application Priority Data
Oct. 16, 2023 (DE) 10 2023 210 117.3

(51) Int. Cl. B65G 17/16

(52) U.S. Cl. CPC B65G 17/16

(57) ABSTRACT

A transfer station for compacting a flow of goods in an overhead conveyor system includes a first conveyor rail, a second conveyor rail, and a plurality of conveyor containers, each container of which is loaded with at least one good and is displaceable along the first conveyor rail. An unloading unit is arranged along the first conveyor rail for automatically unloading the at least one goods from the plurality of conveyor containers. At least one collecting conveyor container is configured to receive the at least one goods and is displaceable along the second conveyor rail.

### CROSS-REFERENCE TO RELATED APPLICATION

The content of the German patent application DE 10 2023 210 117.3 is incorporated herein by reference.

### FIELD

The invention relates to a method and a transfer station for compacting a flow of goods in an overhead conveyor system.

### BACKGROUND

DE 10 2021 207 911 A1 discloses an overhead conveyor system with which individual goods are conveyed suspended in transport bags. The transport bags are conveyed individually to an unloading station, where they are unloaded, the individual goods are loaded into a shipping container and packed automatically. The fact that the individual goods are transported separately in the transport bags allows individual and targeted navigation of the individual goods through the overhead conveyor system to the unloading station. The individual goods transported in the transport bags can be temporarily stored and/or sorted in the overhead conveyor system. If only one individual item is transported in each transport bag, the transport capacity of the overhead conveyor system and the storage capacity of a storage system based on the transport bags is limited.

### SUMMARY

The object of the present invention is to increase the transport capacity and storage capacity of an overhead conveyor system.

This object is achieved by a method having the features specified in the disclosure and by a transfer station having the features specified in the disclosure. It has been recognized that goods which are conveyed suspended in conveyor containers in an overhead conveyor system can be automatically unloaded from the conveyor containers and transported onwards in a collective conveyor container. The collective conveyor container is used to simultaneously convey several goods that were previously conveyed individually in conveyor containers. It is possible to compact the flow of goods in the overhead conveyor system and thereby increase the transport capacity and storage capacity of the overhead conveyor system. The loaded collecting conveyor container is conveyed suspended along the overhead conveyor system. In particular, the conveyor container and/or the collecting conveyor container are designed as a transport bag, which can be conveyed along a conveyor rail in the overhead conveyor system, in particular by means of an overhead adapter. In particular, the collecting conveyor container is designed identically to the overhead conveyor container. In particular, a first conveyor rail, with which the conveyor containers are conveyed, is designed identically to a second conveyor rail, with which the collecting conveyor containers are conveyed. The fact that the transport bags can be used both as conveyor containers and as collecting conveyor containers increases the flexibility in the use of the transport bags. The system investment is reduced.

In particular, it is not necessary to determine the subsequent processing of the goods when loading the conveyor containers. In particular, it is possible to compact the flow of goods by means of automatic transfer of the goods, even if the use of the goods is not yet known or not yet determined when loading a conveyor container with goods.

In particular, the loading of the conveyor containers with goods can take place independently of the orders. This application is particularly relevant when handling returned goods, especially in the field of e-commerce. In particular, the conveyor containers act as a buffer element and/or storage stage. If a customer order comprises several goods that are already present in the flow of goods in the overhead conveyor system, in particular as returned goods, it is possible to determine that they belong together even after the conveyor containers have been loaded. These goods can be unloaded into the collecting conveyor container and collected there, i.e. transported onwards in a compacted state.

Another advantageous application is the handling of mail items in particular. Experience shows that, within a certain time interval, for example spread over a day, different mail items, i.e. goods, arrive at a sorting destination in the overhead conveyor system. However, it is unknown when and how many goods will arrive. The goods already belong together, however, when they are loaded. Due to the staggered arrival of the goods in terms of time and/or space, joint loading into a collective conveyor container is not possible from the outset. Automated transfer into the collective conveyor container is possible despite the staggered arrival in terms of time and/or space. This enables automated transfer of at least a partial quantity of the order goods and, in particular, of all the order goods.

In particular, it possible to decouple the conditions which, according to the prior art, are necessarily linked to each other, i.e. that all order goods must be ready at the loading station at the same time and their logical relationship must be known from the outset. Since these conditions are rarely fulfilled simultaneously in many conveyor technology applications, the invention opens up new areas of application in the handling and sorting of goods.

Due to the increased transport capacity, the number of required destinations, in particular the required packing stations, in the overhead conveyor system can be reduced. The investment costs for the overhead conveyor system and in particular the space requirement are reduced. The increased storage capacity reduces costs. Operating costs are reduced due to automatic transfer.

It is particularly advantageous if exactly one item is transported in each conveyor container. In particular, the goods are uniquely identified when they are loaded into the conveyor container and logically assigned to the conveyor container. The conveyor container is assigned a unique identification, in particular by means of the overhead adapter. The conveyor container and the goods conveyed in it can be uniquely identified within the overhead conveyor system, in particular by means of several identification units arranged along the overhead conveyor system, which are able to detect, in particular read, the identification code of the conveyor containers.

A method simplifies the automatic unloading of the conveyor containers. The design of a conveyor container that enables automatic opening on its underside and the automatic opening of the conveyor container is known from DE 10 2021 207 911 A1, to which express reference is hereby made.

A method enables intermediate storage, i.e. buffering, of the goods from the conveyor containers before the goods are discharged into the collecting conveyor container. In particular, this makes it possible to decouple the unloading of the conveyor containers and the loading of the collecting conveyor container in terms of time. In particular, it is not necessary for the conveyor containers that are to be unloaded into a collecting conveyor container to be conveyed to the unloading station within a narrow time window. The preparation time for the collecting conveyor container is reduced. The capacity utilization is increased. In particular, the goods are automatically unloaded from the conveyor containers into the buffer store, collected there and, in particular, automatically transferred to the collecting conveyor container. The automatic unloading of the goods from the conveyor containers into the buffer store is in particular automatic and in particular gravity-dependent. Unloading is particularly straightforward. In particular, there is no need for additional removal means to remove the goods from the conveyor containers.

A method simplifies the automatic, in particular gravity-induced, unloading of goods from a conveyor container. In particular, the goods are unloaded from the conveyor containers directly into the buffer store. Additional unloading means, in particular a chute, are unnecessary.

An entry detection unit increases safety during automatic transfer. The risk that the goods fed to the buffer store are incomplete is reduced and, in particular, eliminated. In particular, it is not necessary to identify the goods when they are delivered to the buffer store. It is sufficient to detect whether the goods have been unloaded correctly from the conveyor container, in particular identified on the conveyor rail, i.e. whether the goods have passed from the conveyor container into the buffer store. In particular, the entry detection unit is designed to generate and/or transmit to a control unit the digital information “Goods delivered to buffer store” or “Goods not delivered to buffer store”. The entry detection unit is uncomplicated and cost-efficient. The identification of the goods, i.e. the associated information, is passed on from the conveyor container to the buffer store. The entry detection unit is used in particular to record the number of goods that are discharged into the buffer store. The entry detection unit is arranged in particular on the buffer store itself, in particular in an entry area of the buffer store, in particular on a feed opening of the buffer store that faces the conveyor container. The entry detection unit is used to logically assign the detected goods to the buffer store.

An exit detection unit functions substantially in accordance with the entry detection unit, to which reference is hereby made.

The exit detection unit is used to detect how many goods are discharged from the buffer store into the collecting conveyor container. In particular, the exit detection unit can be used to recognize whether the buffer store has been completely emptied or whether one or more goods have been left behind in the buffer store, particularly by mistake. If the buffer store is empty, the goods previously stored in the buffer store are logically added to the collecting conveyor container. Like the entry detection unit, the exit detection unit generates a digital signal. The detection process by means of the exit detection unit is straightforward. It is not necessary to identify the goods from the buffer store. The identification of the goods is inherited from the buffer store when the goods are transferred to the collecting conveyor container.

A method simplifies the automatic discharge of the goods from the buffer store into the collecting conveyor container.

A method enables a logically advantageous transfer of the goods into the collecting conveyor containers. In particular, it has been recognized that a variable number of conveyor containers can be unloaded into a collecting conveyor container. The number of conveyor containers to be unloaded can be determined, in particular as a function of at least one characteristic of the goods. In particular, it has been recognized that, depending on the goods to be transported, there are significant differences in size with regard to the combined length and girth, volume and/or weight of the individual goods. The differences in size can be at least tenfold, in particular at least twentyfold, in particular at least fiftyfold and up to one hundredfold. This applies in particular to the handling of letters and/or parcels. For example, a volume calculation can be used as a basis in order to avoid exceeding a maximum volume of the collecting conveyor containers. In particular, the collection of goods in the buffer store is terminated when a predeterminable threshold value is reached, in particular a maximum volume and/or a maximum weight that can be transported by means of the collecting conveyor container. However, the goods can also be collected in the buffer store, depending on the order.

A transfer station substantially has the advantages one or more of the methods, to which reference is hereby made.

A transfer station enables the goods discharged from the conveyor containers to be temporarily stored in a buffer store. The buffer store has a switchable discharge element in order to discharge the goods collected in the buffer store in a targeted manner into the collecting conveyor container and thereby compact the flow of goods in the overhead conveyor system. The switchable discharge element is designed to be switchable between a collection position, in which the goods are collected in the buffer store, and a discharge position, in which the goods are discharged from the buffer store. For this purpose, the discharge element is mechanically coupled to an actuator, in particular a switchable actuator.

A transfer station simplifies the automatic unloading of the conveyor containers.

A transfer station enables the collected goods to be discharged automatically from the buffer store.

A transfer station enables the uncomplicated detection of the goods when they are fed into or discharged from the buffer store.

The design of the discharge element is efficient. In particular, the discharge element is designed as a hinged flap so that the goods can fall out of the buffer store by gravity. Alternatively, the openable base can be designed as a laterally displaceable plate in the manner of a slider.

Alternatively, it is conceivable that the buffer store is designed to be displaceable, in particular tiltable about a tilting axis, so that the goods are discharged through a feed opening through which they were previously fed to the buffer store. The goods are therefore tipped out of the buffer store.

An opening unit increases the reliability when the goods are discharged from the buffer store into the collecting conveyor container.

A chute surface improves the targeted delivery of goods into the collecting conveyor container.

The arrangement of the exit detection unit on the chute surface increases the reliability in detecting the goods discharged into the collecting conveyor container.

Both the features specified in the claims and the features specified in the following exemplary embodiment of a transfer station are each suitable, either on their own or in combination with one another, for further forming the subject matter according to the disclosure. The respective combinations of features do not represent any restriction with regard to the developments of the subject matter of the disclosure, but are fundamentally merely exemplary in character.

Further features, advantages and details of the disclosure can be found in the following description of exemplary embodiments with reference to the drawing, in which:

### BRIEF DESCRIPTION OF THE DRAWINGS

FIG. 1 shows a schematic view of an overhead conveyor system,

FIG. 2 shows an enlarged, partially cut-away view of an overhead conveyor system of the overhead conveyor system,

FIG. 3 shows a perspective view of a transport bag loaded with a good as a conveyor container,

FIG. 4 shows a perspective view of a transfer station,

FIG. 5 shows an enlarged, partially cut-away view of the transfer station according to FIG. 4.

### DETAILED DESCRIPTION

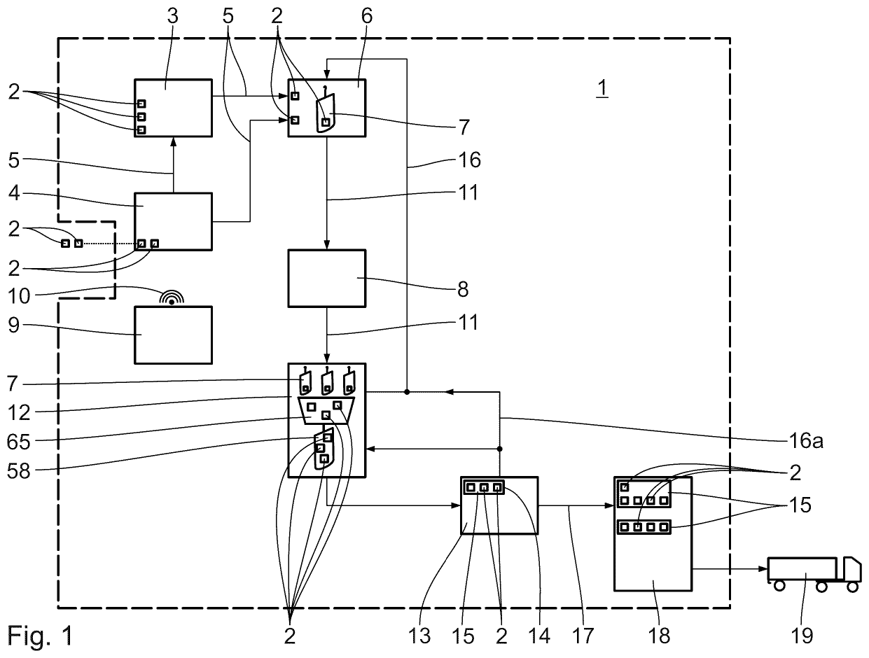

A system labelled 1 as a whole in FIG. 1 is used for conveying and/or transporting goods 2. The goods 2 are conveyed individually in particular and are therefore also referred to as individual goods. The system 1 is an overhead conveyor system. The individual goods 2 are also referred to as articles. The system 1 comprises a warehouse 3 in which the individual goods 2 are stored. The goods warehouse 3 can be designed as a manual warehouse or as an automatic warehouse. The system 1 also has a goods receiving area 4, via which individual goods 2 are supplied to the system 1, in particular from outside. Returned goods can also be fed to the goods receiving area 4.

The goods receiving area 4 is connected to the warehouse 3 by means of a conveyor system 5. The conveyor system 5 is, for example, a conveyor belt or a manual feed of the individual goods 2, which may also be present in packs in the goods receiving area 4, to the warehouse 3.

The system 1 also comprises a feed station 6, at which the individual goods are loaded into a carrying device 7, which is also referred to as a conveyor container 7 and is designed as a transport bag. The feed station 6 is also referred to as the loading station, as the transport bags 7 are each loaded with an article 2. The feed station 6 is connected to both the goods receiving area 4 and the warehouse 3, in each case independently by means of a conveyor system 5. The conveyor system 5 is used to convey the individual goods 2 from the warehouse 3 and/or the goods receiving area 4 to the feed station.

It is also possible to design the system 1 without a conveyor system between the feed station 6 and the goods receiving area 4 or the warehouse 3. In this case, the individual goods 2 are conveyed manually from the goods receiving area 4 and/or the warehouse 3 to the feed station 6, in particular by means of adjustable-base carts or pallet trucks.

The carrying devices 7 can each be transported individually in a rail system by means of a roller adapter, not shown in detail in FIG. 1. The roller adapter is also known as an overhead adapter. The carrying devices 7 are transported suspended. The system 1 is an overhead conveyor system. It is advantageous if the carrying devices 7 can each be clearly identified by means of an identification device. For this purpose, each roller adapter can have an integrated RFID chip on which identification data are stored. The identification data can be detected by suitable reading devices, which are arranged in particular along the transport path of the overhead conveyor system 1, in order to track and control the transport path of the carrying devices 7 along the overhead conveyor system 1.

For suspended conveying in the overhead conveyor system 1, the carrying devices 7 are each form-fittingly connected to a roller adapter. In particular, the carrying devices 7 each have a hook that can be hooked into a corresponding recess in the roller adapter. A clothes hanger with an item of clothing hanging from it can also be hooked into the recess of the roller adapter. In particular, each carrying device 7 is used to convey exactly one individual good 2.

Alternatively, the roller adapter can also be hook-shaped and hooked into a recess in the carrying device 7.

The overhead conveyor system 1 comprises a sorting unit 8, which is used to sort the carrying devices 7, i.e. to change the order of the individual goods in the flow of goods. The sorting unit 8 can be of various designs. The sorting unit 8 is also known as a bag sorter. The sorting unit 8 can have several accumulation sections arranged in parallel and/or in series and/or one or more circulating carousels. Additionally or alternatively, the sorting unit 8 can be designed as a matrix sorter.

The sorting unit 8 is used in particular to collate the individual goods 2 into logical groups. In particular, the individual goods 2 are combined into groups of individual goods 2 that form an order 15. Groups of individual goods 2 that are part of an order 15 can also be formed in the sorting unit 8.

The overhead conveyor system 1 comprises a central control unit 9, which has a signalling connection, in particular with the reading devices along the overhead conveyor system 1. The signalling connection can be wired or wireless. A wireless, radio-based signalling connection is shown in FIG. 1 with a symbol 10 for radio transmission.

The overhead conveyor system 1 comprises a rail system 11, by means of which the carrying devices 7 are conveyed from the feed station 6 to the sorting unit 8 and through the sorting unit 8. The rail system 11 also serves to connect the sorting unit 8 to at least one transfer station 12 by means of conveying. In particular, there are several transfer stations 12. At the transfer station 12, the conveyor containers 7 are automatically opened and unloaded, the goods 2 are collected from the conveyor containers 7 in a buffer store 65 and discharged into a collecting conveyor container 58. The collecting conveyor container 58 is used to convey a plurality of goods 2, in particular in an order-oriented manner, from the transfer station 12 to a packing station 13 and, in particular, to automatically pack them into a packaging container 14.

In particular, several transfer stations 12 are provided. At the transfer station 12, the carrying devices 7 are automatically opened and unloaded, in particular by the individual goods 2 falling downwards out of the open carrying device 7 due to gravity. An opening unit, not shown in detail, is used to automatically open the carrying devices 7 in the transfer station 12. The opening unit is an unloading unit.

As an alternative to the opening unit, the transfer station 12 can also have an adjusting element, not shown in detail, in order to swivel the transport bag 7 in the unloading position about a swivel axis, in particular one that is oriented horizontally and in particular perpendicular to the conveying direction of the transport bag 7, or laterally about a swivel axis, in particular one that is oriented parallel to the conveying direction of the transport bag 7, and thereby to tip the article 2 out of the transport bag 7.

It is key that the transfer station 12 enables automatic unloading of the transport bags 7.

The carrying devices 7 emptied in the transfer station 12 are returned via a return section 16 of the overhead conveyor system 1, closed by means of a closing unit (not shown), i.e. returned to their original state, and made available again, for example at the feed station 6 as empty bags for loading with individual goods 2.

A return section 16a is also connected to the packing station 13 and opens into the return section 16 in order to return the unloaded collecting conveyor containers 58 for renewed loading. Accordingly, the return section 16a, as shown in FIG. 1, can also be returned directly to the transfer station 12.

It is advantageous that the conveyor containers 7 and the collecting conveyor containers 58 are designed identically, so that their use in the overhead conveyor system 1 is particularly flexible.

The packing station 13 is connected by a conveyor system to a discharge section 17, which connects the packing station 13 to a goods outlet 18. The orders 15 with the individual goods 2 can leave the system 1 via the goods outlet 18. The orders 15 processed in the system 1 can comprise different articles and different numbers of articles. It is also conceivable that an order 15 only contains a single individual good 2. Orders 15 from the goods outlet 18 can be transported away by external means of transport 19 such as lorries.

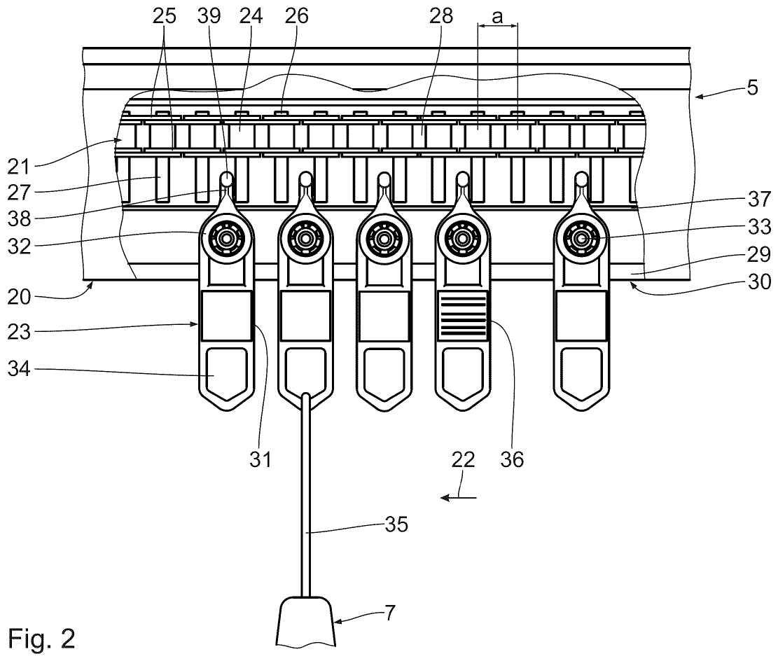

The conveyor system 5 is explained in greater detail below with reference to FIG. 2. The conveyor system 5 has a transport rail 20, which is also referred to as the first conveyor rail 20 and which can be moved in a room by means of suitable carrying devices. A drive chain 21 is arranged in the transport rail 20 and is designed as a hollow box profile and can be driven along a conveying direction 22 by drive means, not shown. Furthermore, retaining elements 23 are provided, which can be moved in the transport rail 20 by means of the drive chain 21. The holding elements 23 are overhead adapters.

The drive chain 21 is a so-called roller chain, which has rollers 24 that are connected to each other at a short distance from each other by means of connecting plates 25. The pins 26 have bolt-shaped extensions projecting downwards and serving as drivers 27. The pins 26 with the drivers 27 run perpendicular to the transport rail 20 in a vertical plane spanned by the conveying direction 22.

The drive chain 21 is guided and held in the transport rail 20 in the direction of the pins 26, i.e. vertically and transversely to the conveying direction 22, by means of guides 28 that engage under the connecting plates 25. The centre-to-centre distance a of adjacent drivers 27 in the transport rail 20 in the conveying direction 22 corresponds exactly to the pitch of the drive chain 21 and is therefore unchangeable and constant.

Two guide ribs 29 are formed on the underside of the transport rail 20 and are directed towards each other, with a slot 30 extending in the longitudinal direction of the transport rail 20, i.e. in the conveying direction 22, being formed or delimited between them. A flat support part 31 of each overhead adapter 23 projects downwards out of the transport rail 20 through this slot 30. In its upper region, the overhead adapter 23 has a roller 32 on each side of the support part 31, which rollers are supported in each case on one of the two guide ribs 29 and can be displaced thereon in the conveying direction 22. There is therefore only one pair of rollers 32, which are rotatable about a common axis 33, so that the entire overhead adapter 23 can oscillate about this axis 33 in the transport rail 20.

At its lower end, the support part 31 has a receiving opening 34 into which the transport bag 7 can be hung, in particular by means of a transport hook 35. An identification element 36, which may be a transponder, in particular an RFID chip or a barcode, is arranged between the receiving opening 34 and the underside of the transport rail 20. The identification element 36 runs in accordance with the arrangement of the plate-like support part 31 in the conveying direction 22, i.e. its main surface is open transversely to the conveying direction 22, i.e. towards the side. It is thus possible to unambiguously detect the identification element 36 via an identification unit, not shown in detail, since it cannot overlap with other identification elements 36.

A transport bag 7 with an article to be transported remains attached to the overhead adapter 23 during the entire transport process once it has been hooked into the overhead adapter 23, i.e. it is “married” to it, so to speak. The article to be transported is controlled via the identification element 36 and thus via the overhead adapter 23.

The transport rail 20 has horizontal delimiting ribs 37, which are directed towards each other directly above the rollers 32 and define a slot between them. A stem-like extension 38 of the overhead adapter 23 extends through this slot and is formed in one piece with the support part 31 at the upper end thereof. At the upper end of this stem-like projection 38, a stop 39 is formed in the manner of a transverse bar, the extent of which horizontally transverse to the conveying direction 22 is greater than the width of the slot, so that, when the overhead adapter 23 is tilted relative to the transport rail 20, this stop 39 comes to rest on the delimiting ribs 37. This prevents the overhead adapter 23 from tilting any further. The projection 38 and the stop 39 therefore have the basic shape of a hammer.

The drivers 27 of the drive chain 21 extend to directly above the delimiting ribs 37 so that an overhead adapter 23 located between two drivers 27 is always reliably entrained, i.e. does not come out of engagement with the driver 27.

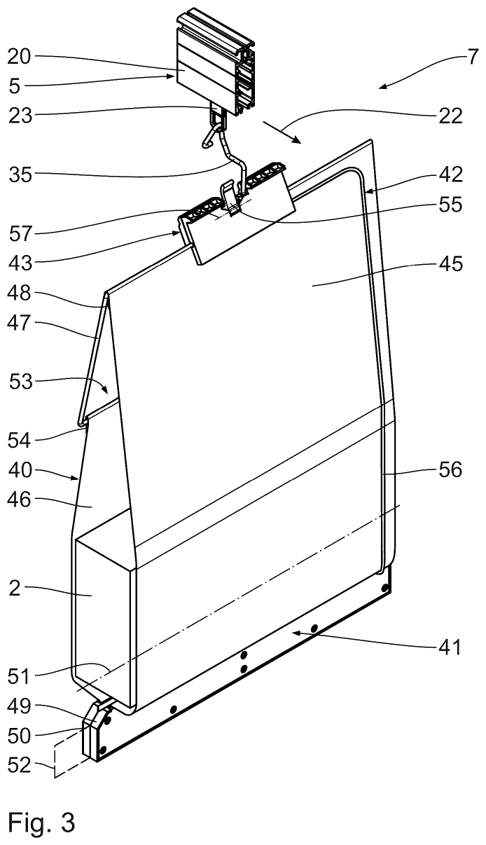

The transport bag 7 is explained in greater detail below with reference to FIG. 3. The transport bag 7 is also referred to as a carrying device.

The transport bag 7, which is also referred to as a carrying device, has a carrying wall 40, a closing device 41, an actuating device 42 and a suspension device 43. The actuating device 42 and the suspension device 43 are part of an opening mechanism of the transport bag 7.

The suspension device 43 is attached to the carrying wall 40. The suspension device 43 comprises a transport hook 35 for fastening the carrying device 7 to the roller adapter 23 of a rail system 5. The rail system 5 corresponds to the conveyor system. The roller adapter 23 is mounted for linear displacement in a guide profile 20 of the rail system 5. The guide profile 20 is a transport rail. By means of a rail drive, not shown, the roller adapter 23 together with the carrying device 7 attached to it can be automatically displaced along the guide profile 20.

The carrying wall 40 has a front wall 45 and a rear wall 46. The front wall 45 is arranged at the front of the carrying device 7 along a transport direction 22 and the rear wall 46 is arranged at the rear along the transport direction 22. The transport direction 22 corresponds to the conveying direction. The front wall 45 is attached to the suspension device 43 via a loading frame 47. For this purpose, the front wall 45 has a frame loop 48 on its upper side. A front side of the loading frame 47 extends through the frame loop 48 of the front wall 45. An upper side of the rear wall 46 is attached to a rear side of the loading frame 47 via a frame loop 54. The front wall 45 and the rear wall 46 are thus attached to the suspension device 43 via the loading frame 47.

The closing device 41 has a front closing strip 49 and a rear closing strip 50. The closing device 41 has a main extent oriented parallel to a longitudinal axis 51 of the carrying device 7. The closing device 41 projects beyond the carrying wall 40 along the longitudinal axis 51 on both sides. The underside of the front wall 45 is attached to the front closing strip 49. The underside of the rear wall 46 is attached to the rear closing strip 50. The carrying device 7 has a centre plane 52 oriented vertically and parallel to the longitudinal axis 51.

In FIG. 1, the carrying device 7 is shown in a closed state. An underside of the front wall 45 is connected to an underside of the rear wall 46 via the closing device 41. The front closing strip 49 is attached to the rear closing strip 50 for this purpose and the carrying wall 40 delimits a carrying volume 53 to the front, rear and bottom. The front closing strip 49 contacts the rear closing strip 50 in the region of the centre plane 52. The front wall 45 and the rear wall 46 are made of a textile material and are flexible in form. The articles 2 arranged in the carrying volume 53 are located on an underside of the carrying wall 40 due to the force of gravity. Due to the flexible, in particular pliable, design of the carrying wall 40, it assumes a shape corresponding to the shape of the articles 2. The articles 2 are thus held firmly in the carrying volume 53.

The actuating device 42 comprises an actuating means 55 and a transmission means 56. The actuating device 42 is designed to release the connection between the front closing strip 49 and the rear closing strip 50 and thus between the front wall 45 and the rear wall 46 from the closed state.

The actuating means 55 is designed as an actuating lever. The actuating means 55 is rotatably mounted on the suspension device 43 about a lever axis 57 oriented parallel to the longitudinal axis 51.

The actuating means 55 is mechanically coupled to the transmission means 56. The mechanical coupling is designed to convert an actuating force oriented against the transport direction 22 into a transmission force oriented parallel to the longitudinal axis 51. The actuating means 55 is in a force-transmitting connection with the transmission means 56.

The transmission means 56 is designed as a Bowden cable. The transmission means 56 extends from the suspension device 43 to the closing device 41.

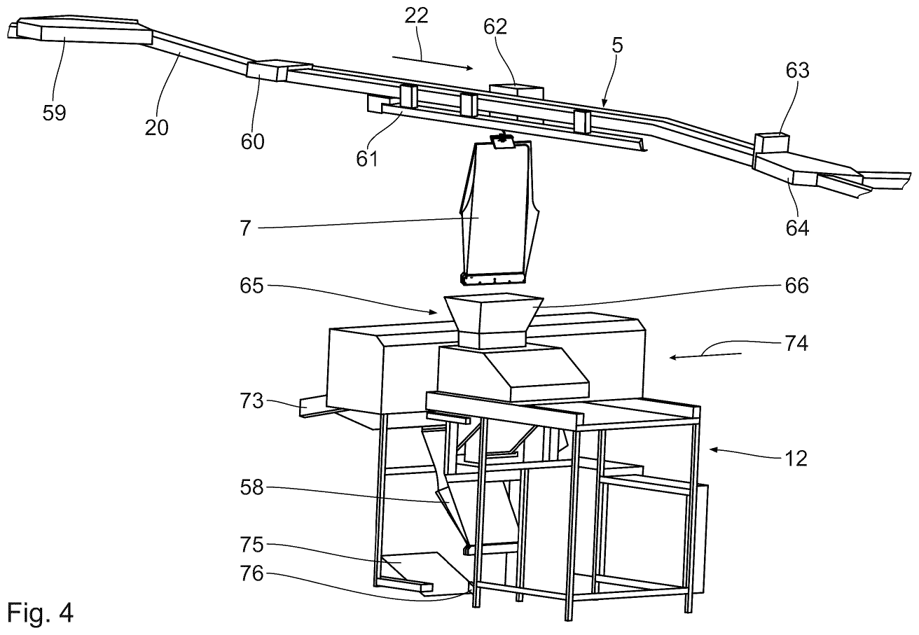

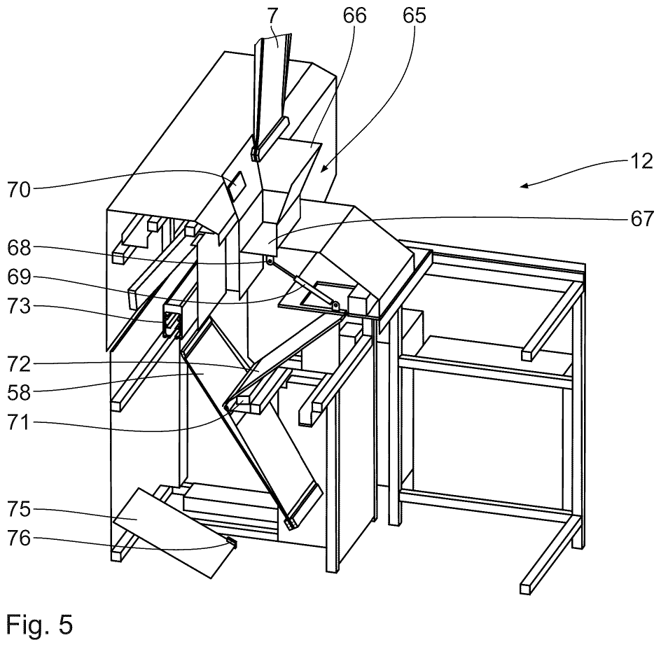

The structure of the transfer station 12 is explained in greater detail below with reference to FIGS. 4 and 5. The transfer station 12 has the first conveyor rail 20. The first conveyor rail 20 forms a feed section for feeding the conveyor containers 7 by means of the overhead adapters 23 along the first conveying direction 22 into an unloading position, which is shown in FIG. 4. The first conveyor rail 20 is in particular a component of the conveyor system 5 of the overhead conveyor system 1.

Upstream of the unloading position, a discharge diverter 59 is arranged on the first conveyor rail 20 in order to feed conveyor containers 7 to be unloaded into the first conveyor rail 20.

A first separating unit 60 is arranged downstream of the discharge diverter 59 and upstream of the unloading position in order to feed the conveyor containers 7 individually to the unloading position.

The unloading position defines a region of the first conveyor rail 20 extending along the first conveying direction 22. The longitudinal extent of this region depends in particular on the conveying speed of the conveyor containers 7 along the first conveyor rail 20.

A lateral guide 61 is arranged on the first conveyor rail 20 in the region of the unloading position. The lateral guide 61 prevents unintentional oscillation of the conveyor containers 7, which are fed into the unloading position, in particular oscillation about an axis parallel to the conveying direction 22. The lateral guide 61 is designed in particular as a static longitudinal element, which is laterally spaced and in particular arranged below the first conveyor rail 20. The lateral guide 61 is fastened, in particular screwed, directly to the first conveyor rail.

In the region of the unloading position, in particular upstream of the unloading position or directly at the unloading position, an end loading unit 62 is arranged on the first conveyor rail 20 and comprises a release mechanism, not shown in greater detail, in order to automatically open the conveyor bags 7 arranged in the unloading position. This automatically unloads the conveyor bags 7. The release mechanism can have an actuating element which serves to actuate the actuating means 55 of the conveyor container 7. The design and function of such a release mechanism are described in DE 10 2021 207 911 A1, to which express reference is hereby made.

A second separating unit 63 is arranged downstream of the unloading position, in particular at the end of the first conveyor rail 20, in order to feed the unloaded conveyor containers 7 into a subsequent conveyor section with fixed entrainment by means of a feed diverter 64, in particular into the return section 16.

The conveyor containers 7 are conveyed along the first conveyor rail 20 downstream of the discharge diverter 59 by gravity. In this region, the first conveyor rail 20 is inclined downwards in relation to the horizontal. After the first separating unit 60, the overhead adapters are conveyed with a fixed entrainment, as explained with reference to FIG. 2. Downstream of the unloading position, the fixed entrainment ends and further conveying of the transport containers 7 to the second separating unit 63 can take place, at least in sections, by automatic, gravity-induced conveying, in that the first conveyor rail 20 is inclined downwards relative to the horizontal. After the second separating unit 63, the transport containers 7 are conveyed by fixed entrainment as shown in FIG. 2.

The transfer station 12 has the buffer store 65. The buffer store 65 is arranged in the region of the unloading position. The buffer store 65 is arranged at a vertical distance below the first conveyor rail 20 at the unloading position. In an upper region facing the first conveyor rail 20, the buffer store 65 has a feed hopper 66.

The buffer store 65 has a feed opening, which is arranged at the top of the buffer store 65, facing the first conveyor rail 20. A discharge opening is formed on the buffer store 65 opposite the feed opening. With respect to a longitudinal axis of the buffer store 65, the feed opening and the discharge opening are arranged concentrically to one another and, in particular, in alignment. The buffer store 65 has a shaft-like design with the longitudinal axis, which is oriented vertically in particular. The buffer store 65 has a buffer volume, which is delimited in particular by the shaft portion, the feed opening and the discharge opening. The buffer volume is suitable for holding several goods, in particular at least three goods, in particular at least five goods, in particular at least ten goods. In particular, the buffer volume is designed in such a way that all goods 2 of a multiple goods order can be temporarily stored in the buffer store 65. In particular, the buffer volume is dimensioned in such a way that the goods of one order can be stored in the buffer volume for at least 90% of all orders.

A switchable discharge element 67 is arranged along the longitudinal axis in the buffer store 65 between the feed opening and the discharge opening and is arranged to swivel about a swivel axis 68. The swivel axis 68 is in particular horizontally oriented and in particular perpendicular to the first conveying direction 22. The swivel axis 68 can also be oriented parallel to the conveying direction 22 or transversely in a horizontal plane.

The discharge element 67 is swivelled in particular by means of a switchable actuator 69, which forms a displacement drive. According to the exemplary embodiment shown, the actuator 69 is designed as a linear displaceable drive, in particular as a pneumatic cylinder. It is understood that the linear drive can also be designed as a hydraulic cylinder or an electromotive spindle drive. A first end of the actuator 69 is held firmly in the transfer station 12 and a second end is attached to an underside of the discharge element 67. In particular, the actuator 69 is integrated in the transfer station 12 in such a way that the unloading of the conveyor containers, the receiving of the goods in the buffer store 65 and the discharging of the goods 2 from the buffer store 65 into the collecting conveyor container 68 is not disturbed by the actuator 69.

According to FIG. 5, the discharge element 67 is in a holding position. In the holding position, a free passage through the shaft-like buffer 65 is blocked. In the holding position, the discharge element 67 is oriented transversely and, in particular, perpendicular to the longitudinal axis. In the holding position, the discharge element 67 is oriented substantially horizontally.

By actuating the actuator 69, in particular by retracting the piston rod into the cylinder, the discharge element 67 is swivelled downwards about the swivel axis 68, in particular into a vertical orientation. In particular, the discharge element 67 is swivelled with respect to the swivel axis 68 by a swivel angle of at least 90° and in particular greater than 90°, so that the discharge element 67 does not impair the free passage of the goods through the buffer store 65.

An entry detection unit 70, which is shown purely schematically in FIG. 5, is arranged on the buffer store 65. The entry detection unit 70 serves to detect the entry of a good 2 into the buffer store 65. The entry detection unit is designed in particular as a light barrier and/or as a light grid. The entry detection unit 70 is oriented transversely and in particular perpendicularly to the longitudinal axis, in particular horizontally. Goods 2 that are conveyed through the buffer store 65 due to gravity must inevitably pass through the entry detection unit 70. In particular, the entry detection unit 70 is arranged vertically above the discharge element 67.

An exit detection unit 71, which is substantially identical to the entry detection unit 70, is arranged vertically below the discharge element 67. The detection units 70, 71 can, for example, be arranged integrated on the side walls of the shaft of the buffer store 65.

It is also conceivable to arrange the detection units 70, 71 outside the shaft, i.e. directly above the upper feed opening or below the lower discharge opening. The detection units 70, 71 are in signalling connection with the control unit 9.

A chute surface 72 is arranged vertically below the buffer store 65, in particular the discharge opening, and is oriented downwards at an angle to the horizontal.

A second conveyor rail 73 is formed at the transfer station 12 and runs vertically below the first conveyor rail 20 and, in particular, vertically below the buffer store 65. In particular, the second conveyor rail 73 is designed identically to the first conveyor rail 20. Overhead adapters 23 can be conveyed in the second conveyor rail 73. The collecting conveyor containers 58, which are designed in particular identically to the conveyor containers 7, are arranged on the overhead adapters 23. The collecting conveyor containers 58 are conveyed along the second conveyor rail 73 along a second conveying direction 74. A stopping device, not shown in detail, is arranged along the second conveyor rail 73. In particular, the stopping device is arranged vertically below the buffer store 65 in order to reliably stop a collecting conveyor container 58 to be loaded below the buffer store 65.

Furthermore, an opening unit is arranged at this position in order to open the collecting conveyor container 58 to be loaded in the loading position. The collecting conveyor container 58 is opened in particular by the collecting conveyor container 58 being swivelled about a swivel axis, in particular a horizontally oriented swivel axis, at the overhead adapters 23, as shown in FIGS. 4 and 5. The collecting conveyor container 58 is thereby swivelled from a vertically downwardly suspended arrangement towards the chute surface 72, thereby opening a loading opening of the collecting conveyor container 58. The collecting conveyor container 58 is opened at its upper side, in particular by swivelling the loading frame 47 into a substantially horizontal position. The loading opening of the collecting conveyor container 58 is delimited by the loading frame 47.

In particular, the collecting conveyor container 58 is opened by forming a coupling between the overhead adapter 23 and the loading frame 47, which allows the collection body container 58 to rotate about a vertical axis of rotation. In particular, a fixed skid, which is not shown in FIG. 5, is arranged in the region of the opening unit and is arranged eccentrically with respect to the vertical axis of rotation of the collecting conveyor container 58.

When the collecting conveyor container 58 moves against the fixed skid, a torque is exerted on the collecting conveyor container 59 about the vertical axis of rotation and said collecting conveyor container is rotated into a loading position in which the loading opening of the collecting conveyor container is oriented parallel to the conveying direction of the second conveyor rail 73. In the transport position, the loading opening of the collecting conveyor container 58 is oriented transversely, in particular perpendicularly, to the conveying direction of the second conveyor rail 73.

The collecting conveyor container 58 is located in the transport arrangement in particular when it is arranged along the conveying direction before or after the fixed skid. In particular, the collecting conveyor container 58 is automatically displaced from the loading arrangement, in particular by gravity, back into the transport arrangement as soon as it is no longer in contact with the fixed skid.

With regard to the design and function of such an opening unit, explicit reference is made to EP 2 418 160 Bl.

Alternatively, it is conceivable that actuating means are provided which, in particular when switched, move the collecting conveyor container 58 from the transport arrangement into the loading arrangement and/or back. In particular, the opening unit is designed to be switchable and is in bidirectional signalling communication with the control unit 9.

Vertically below the loading position in the transfer station 12, in particular close to the floor, there is arranged a baffle plate 75 with a misloading sensor 76. The baffle plate 75 and the misloading sensor 76 are arranged in the transfer station 12 in particular in such a way that a good 2 discharged from the buffer store 65, which is inadvertently not discharged into a provided and opened collecting conveyor container 58, can be detected. This additionally reduces the risk that an unintentional incorrect loading or non-loading is reliably detected and recognized as an error. In particular, this makes it possible to detect goods 2 that are guided along the chute surface 72 past the exit detection unit 71 and thus detected, but which do not end up in the collecting conveyor container 58 but on the baffle plate 75 due to a fault.

In particular, the first conveyor rail 20 and the second conveyor rail 73 are connected by means of a conveyor system.

The function of the transfer station is explained in greater detail below on the basis of FIGS. 4 and 5.

Conveyor containers 7, each loaded with exactly one good 2 in particular, are fed to the first conveyor rail 20 in the overhead conveyor system 1 by means of the discharge diverter 59 and conveyed to the unloading position.

For this purpose, the conveyor containers 7 are separated at the first separating unit 60. The lateral guide 61 prevents unintentional oscillating movement of the conveyor containers 7.

In the unloading position, the conveyor container 7 is automatically opened at its underside by means of the unloading unit 62. The good 2 contained in the conveyor container 7 falls out from the underside of the conveyor container 7 due to gravity and passes through the feed hopper 66 into the buffer store 65. It is advantageous if the automatic unloading of the conveyor containers 7 takes place without the conveying movement of the conveyor containers 7 having to be stopped. The conveyor containers 7 are opened, so to speak, “in passing” at the unloading position. Such an automatic unloading process is particularly efficient and enables a high throughput rate during unloading.

After unloading, the emptied conveyor container 7 is transported from the unloading position to the second separating unit 63 and to the feed diverter 64, by means of which the emptied conveyor container 7 is returned to the overhead conveyor system 1 and, in particular, conveyed further via the return section 16.

Subsequently, further conveyor containers 7 can be successively unloaded into the buffer store 65, wherein the individual goods 2 are temporarily stored in the buffer store 65. Controlled in particular by the control unit 9, the goods 2 are collected in the buffer store 65, in particular depending on the size, i.e. the volume and/or the combined length and girth and/or depending on the weight of the goods 2. In particular, when a permissible threshold value for the volume and/or weight of the collected goods 2 in the buffer store 65 is reached, the collected goods are discharged from the buffer store 65.

The unloading of the goods 2 from the conveyor containers 7 into the buffer store 65 is detected by the entry detection unit 70. The discharge of the goods 2 from the buffer store 65 into the collecting conveyor container 58 is detected by the exit detection unit 71. It is advantageous that the fundamental information of the goods 2 was linked to the respective conveyor container 7. When the goods 2 are discharged from the respective conveyor container 7, the corresponding information is logically passed on to the buffer store 65.

The goods 2 are discharged by swivelling the discharge element 67, which is arranged in the holding position according to FIG. 4 for collecting the goods 2, into the discharge position by means of the actuator 69. The goods 2 can move automatically, i.e. by gravity, from the buffer store 65 into the collecting conveyor container 58 arranged below, in particular through the loading frame 47. When the goods are discharged from the buffer store 65 into the collecting conveyor container 58, the corresponding information of the goods 2 is logically passed on to the collecting conveyor container 58.

In the unlikely event that a good 2 is unintentionally misloaded, i.e. does not end up in a collecting conveyor container 58, this good 2 is detected at the baffle plate 75 and the misloading sensor 76 and a corresponding error signal is transmitted to the control unit 9.

The loaded collecting conveyor container 58 is swivelled from the opening position according to FIG. 4 back into a vertically suspended transport position and can then be conveyed out of the transfer station 12 along the second conveyor rail 73. In particular, the collecting conveyor container 58 loaded in this way is conveyed to a packing station 13, where the goods can be loaded into a packing container 14.

The goods 2 can be conveyed efficiently and purposefully in the overhead conveyor system 1 by means of the transfer station 12. In particular, the transfer station enables an advantageous compaction of the flow of goods.

What is claimed is:

1. A method for compacting a flow of goods in an overhead conveyor system, the method including:
conveying overhead a plurality of conveyor containers, each conveyor container of the plurality of conveyor containers loaded with at least one good in the overhead conveyor system;
unloading automatically the at least one good from each conveyor container of the plurality of conveyor containers into a collecting conveyor container; and
conveying overhead the collecting conveyor container loaded with the at least one good from each conveyor container of the plurality of conveyor containers in the overhead conveyor system.

2. The method according to claim 1, wherein the unloading automatically the at least one good from each conveyor container of the plurality of conveyor containers includes opening automatically each conveyor container on an underside.

3. The method according to claim 1, wherein the unloading automatically the at least one good from each conveyor container of the plurality of conveyor containers includes unloading into a buffer store and discharging the goods from the buffer store into the collecting conveyor container.

4. The method according to claim 3, wherein the conveyor containers of the plurality of conveyor containers are each arranged vertically above the buffer store during the unloading into the buffer store.

5. The method according to claim 3, further including detecting with an entry detection unit the at least one good from each conveyor container of the plurality of conveyor containers unloaded into the buffer store.

6. The method according to claim 3, further including detecting with an exit detection unit the goods discharged from the buffer store into the collecting conveyor container.

7. The method according to claim 3, wherein the collecting conveyor container is arranged vertically below the buffer store while the goods are discharged from the buffer store.

8. The method according to claim 3, wherein the unloading into the buffer store includes unloading based at least in part on at least one property of the goods, the at least one property one of at least 1) good volume or 2) a combined good length and girth or 3) good weight or 4) good order.

9. A transfer station for compacting a flow of goods in an overhead conveyor system, the transfer station comprising:
a first conveyor rail;
a plurality of conveyor containers, each container of which is loaded with at least one good and is displaceable along the first conveyor rail;
an unloading unit arranged along the first conveyor rail for automatically unloading the at least one goods from the plurality of conveyor containers;
a second conveyor rail; and
at least one collecting conveyor container, the at least one collecting conveyor container configured to receive the at least one goods, the at least one collecting conveyor container displaceable along the second conveyor rail.

10. The transfer station according to claim 9, further including a buffer store for receiving the at least one goods from the plurality of conveyor containers, wherein the buffer store includes a switchable discharge element for automatically discharging the goods received.

11. The transfer station according to claim 10, wherein the first conveyor rail is arranged vertically above the buffer store.

12. The transfer station according to claim 10, wherein the second conveyor rail is arranged vertically below the buffer store.

13. The transfer station according to claim 10, further including an entry detection unit for detecting goods received into the buffer store or an exit detection unit for detecting goods discharged from the buffer store.

14. The transfer station according to claim 11, wherein the switchable discharge element is configured as an openable base, which is displaceable or pivotable in a base plane.

15. The transfer station according to claim 9, further including an opening unit for automatically opening the at least one collecting conveyor container arranged along the second conveyor rail.

16. The transfer station according to claim 15, further including a chute surface arranged vertically below the buffer store and facing the opening unit.

17. The transfer station according to claim 16, further including an exit detection unit arranged in an end region of the chute surface.
